(19) United States
(12) Patent Application Publication
(10) Pub. No.: US 2006/0175391 A1
(43) Pub. Date: Aug. 10, 2006

(54) Electronic device and display control method

(76) Inventor: Takahiro Yamaguchi, Kanagawa (JP)

Correspondence Address: RADER FISHMAN & GRAUER PLLC, LION BUILDING, 1233 20TH STREET N.W., SUITE 501, WASHINGTON, DC, 20036, US

(21) Appl. No.: 11/337,565

(22) Filed: Jan. 24, 2006

(30) Foreign Application Priority Data
Feb. 4, 2005 (JP) JP 2005-029338

(51) Int. Cl. G06F 17/00

(52) U.S. Cl. 235/375

(57) ABSTRACT

An electronic device having a demonstration display function in a power-off state includes: display control means for showing demonstration display on a display part when a demonstration display setting for deciding whether the demonstration display should be shown or not is in an operating state, and showing no demonstration display when the demonstration display setting is in a non-operating state; and setting changing means for changing the demonstration display setting to the non-operating state when the electronic device is turned on through a remote control, so that the demonstration display is shown and canceled with a simple operation.

### CROSS REFERENCES TO RELATED APPLICATIONS

The present invention contains subject matter related to Japanese Patent Application JP 2005-029338 filed in the Japanese Patent Office on Feb. 4, 2005, the entire contents of which being incorporated herein by reference.

### BACKGROUND OF THE INVENTION

1. Field of the Invention

The present invention relates to an electronic device and a display control method which are suitably applied to, for example, audio equipment.

2. Description of the Related Art

In the past, some electronic devices such as audio amplifiers and digital versatile disk (DVD) players have a demonstration display (hereinafter, simply referred to as demonstration display) function of demonstrating the electronic devices to customers in stores to promote sales. In the demonstration display, information on the functions and characteristic configurations or the like of an electronic device is displayed as characters or images on a display part of the electronic device in a power-off state.

Such demonstration display is not necessary when the user purchases the device for home use, and thus it is desirable that a display cancellation state having no demonstration display is available with a simple operation; meanwhile it is desirable that the display should not be easily canceled by customers in stores.

In order to respond to these contradicting requests, an electronic device is proposed in which demonstration display can be started and canceled only by a remote control specially designed for a store (refer to Japanese Patent Laid-Open No. 2004-304487).

### SUMMARY OF THE INVENTION

For this electronic device, however, it is necessary to prepare a remote control in each store.

Another electronic device is proposed in which demonstration display is started and canceled by a special operation such as simultaneous pressing of two or more buttons provided on the electronic device. In this case, the user has to perform such a complicated special operation and the demonstration display might be canceled by customers who know the special operation.

According to an embodiment of the present invention designed in consideration of these points, an electronic device and a display control method are proposed whereby demonstration display can be easily started and canceled with a simple operation and the display can be positively prevented from being reset.

According to another embodiment of the present invention, there is provided an electronic device enabling demonstration display in a power-off state, the device including: display control means for showing the demonstration display on a display part when a demonstration display setting for deciding whether the demonstration display should be shown or not is “on” (operating state), and showing no demonstration display when the demonstration display setting is “off” (non-operating state); and setting changing means for changing the demonstration display setting to “off” when the electronic device is turned on through an external operating device (remote control). The demonstration display setting is “on” in the initial state of the electronic device.

With this configuration, the demonstration display can be automatically started only by connecting the electronic device to a commercial power supply, and the demonstration display can be canceled only by turning on the electronic device through the external operating device.

In the case of a change in the demonstration display setting on the setting menu, even when the electronic device is turned on through the external operating device, the setting changing means does not change the demonstration display setting. The setting on the setting menu can be changed only through the external operating device.

With this configuration, by changing the demonstration display setting to “on” on the setting menu, the demonstration display is continued even when the electronic device is turned on through the external operating device.

According to another embodiment of the present invention, the demonstration display can be automatically started only by connecting the electronic device in the initial state to a commercial power supply, and the demonstration display can be cancelled only by turning on the electronic device through the external operating device. Further, by changing the demonstration display setting to “on” on the setting menu, the demonstration display can be continued even when the electronic device is turned on through the external operating device.

### BRIEF DESCRIPTION OF THE DRAWINGS

Embodiments of the present invention will be described in detail based on the following figures, wherein:

FIG. 1 is a schematic diagram showing the external configuration of an electronic device according to an embodiment of the present invention;

FIG. 2 is a schematic diagram showing the external configuration of a remote commander;

FIG. 3 is a block diagram showing the circuit configuration of the electronic device; and

FIG. 4 is a flowchart showing the steps of controlling demonstration display.

### DETAILED DESCRIPTION OF THE PREFERRED EMBODIMENTS

An embodiment of the present invention will be specifically described below in accordance with the accompanying drawings.

(1) The Configuration of an Electronic Device

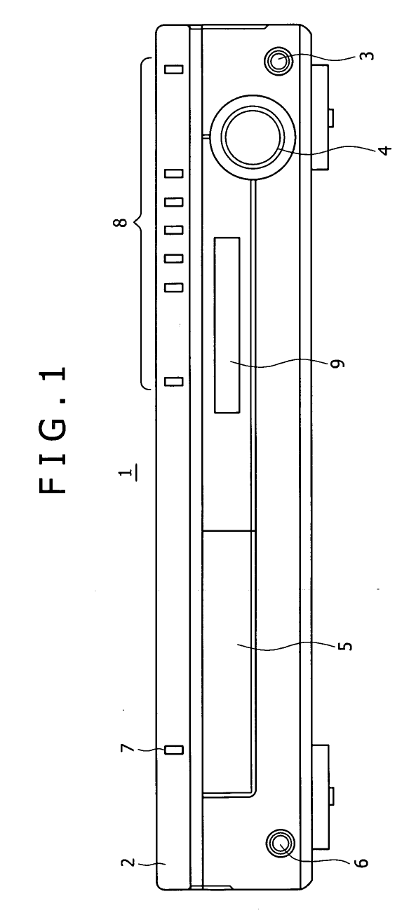

In FIG. 1, reference numeral 1 denotes an overall electronic device according to an embodiment of the present invention. Actually the electronic device 1 is a DVD player with a built-in surround amplifier. A home theater can be easily obtained by connecting external speakers and an external monitor.

A push-push power supply button 3 for turning on/off the electronic device 1 is provided on the lower right end of a front panel 2 of the electronic device 1. A volume dial 4 for adjusting the volume of reproduction is provided on the left of the power supply button 3.

A disk tray 5 for loading optical disks such as a DVD and a compact disk (CD) is provided so as to open and close on the left part of the front panel 2. A tray open/close button 6 for opening/closing the disk tray 5 is provided on the lower left of the disk tray 5. The electronic device 1 has a disk changer function by which two or more optical disks are stored in the electronic device 1 and one of the disks is selected and reproduced.

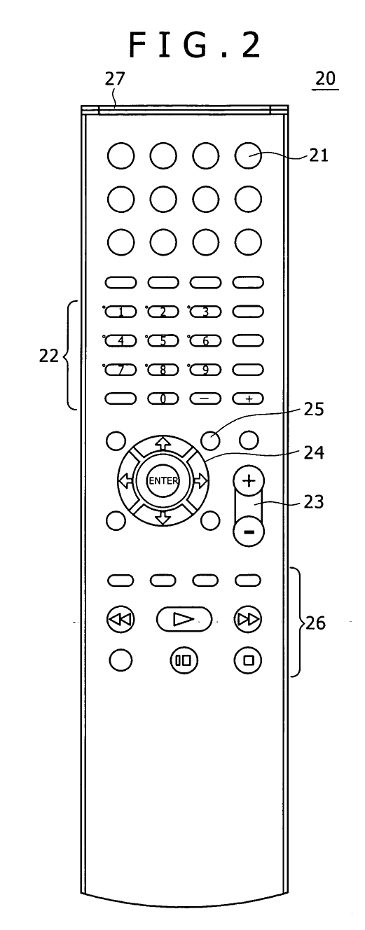

An infrared ray receiving part 7 for receiving an infrared ray transmitted from a remote commander 20 (FIG. 2) is provided on the upper left part of the front panel 2. A plurality of display lamps 8 for displaying an operating state of the electronic device 1 are provided on the right of the infrared ray receiving part 7. A display part 9 of a vacuum fluorescent display is provided under the display lamps 8 to display in detail an operating state as a character string.

The display part 9 can simultaneously display ten characters such as alphabets and numbers at the maximum. When the electronic device 1 is turned on, the display part 9 notifies the user of specific operation information including the operation mode of the electronic device 1, the track number and reproduction elapsed time of an optical disk during reproduction, and various set values.

FIG. 2 shows the external configuration of a remote commander 20 which is an external operating device included in the electronic device 1. The remote commander 20 includes a push-push power supply button 21 for turning on/off the electronic device 1, a ten key 22, a volume button 23 for adjusting the volume of reproduction, a cross key 24 used for moving a cursor and making a decision on a setting menu or the like on the display part 9 (FIG. 1) or a monitor (not shown), a menu button 25 for starting the setting menu, a reproduction button 26 for providing instructions for the reproduction of an optical disk, and an infrared ray transmitting part 27 for transmitting operation signals to the electronic device 1 through infrared rays according to various operations.

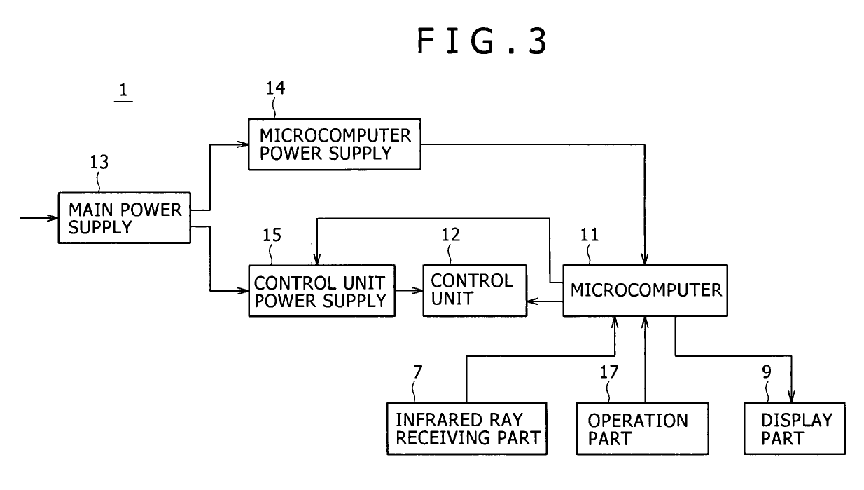

FIG. 3 shows the circuit configuration of the electronic device 1 in which a microcomputer 11 controls the overall electronic device 1 through a control unit 12. The electronic device 1 includes a main power supply 13 for reducing and rectifying the voltage of a commercial power supply of 100 V, and a microcomputer power supply 14 and a control unit power supply 15 which feed power to the microcomputer 11 and the control unit 12, respectively, in response to power fed from the main power supply 13. With this configuration, the electronic device 1 can separately feed power to the microcomputer 11 and the control unit 12.

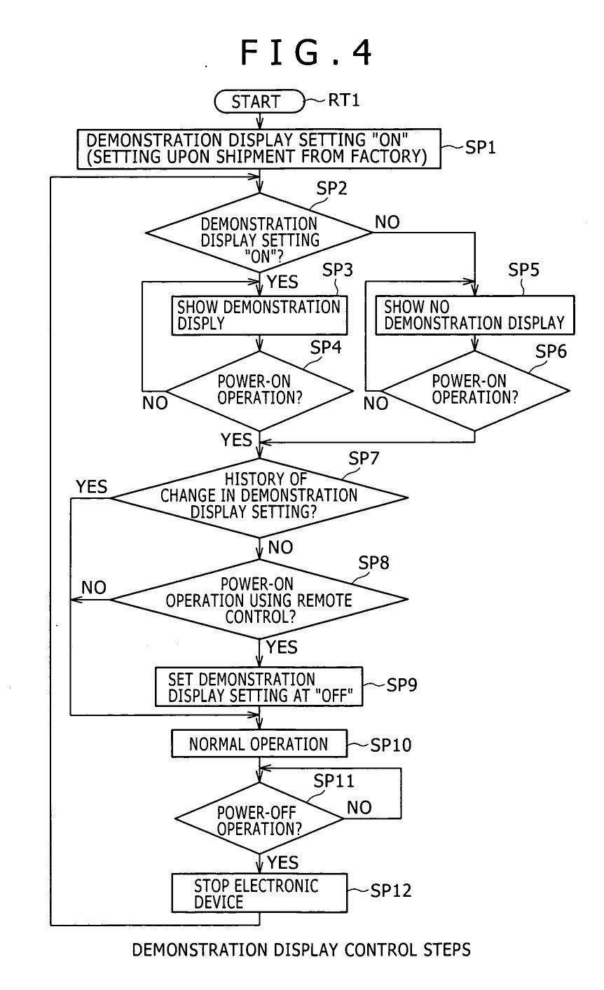

The microcomputer 11 includes read only memory (ROM, not shown) where the control programs of FIG. 4 are written, random access memory (RAM) for a work area, and nonvolatile RAM for storing various kinds of data. The control programs stored in the ROM are read and executed to control the operations of the electronic device 1.

Further, an operation part 17 including the power supply button 3, the tray open/close button 6, and the volume dial 4 (FIG. 1), the display part 9, and the infrared ray receiving part 7 are connected to the microcomputer 11.

In a state in which the main power supply 13 is connected to a commercial power supply, power is typically fed from the microcomputer power supply 14 to the microcomputer 11 in the electronic device 1, so that the microcomputer 11 typically operates even when the electronic device 1 is turned off. In a power-off state, when the power supply button 3 of the operation part 17 is pressed or the power supply button 21 (FIG. 2) of the remote commander 20 is pressed, the microcomputer 11 brings the overall electronic device 1 into a power-on state to start the electronic device 1 in response to the operation. In other words, the microcomputer 11 controls the control unit power supply 15 in response to a power-on operation and starts feeding power to the control unit 12 and the parts of the electronic device 1.

Further, in a state in which the electronic device 1 is turned on, when the power supply button 3 of the operation part 17 is pressed or the power supply button 21 of the remote commander 20 is pressed, the microcomputer 11 brings the overall electronic device 1 into the power-off state to stop the electronic device 1 in response to the operation.

(2) Display Control of Demonstration Display According to an Embodiment of the Present Invention

In addition to this configuration, the electronic device 1 has a demonstration display function by which information on the functions and characteristic configurations of the electronic device 1 is displayed as a character string on the display part 9. The demonstration display is shown only when a demonstration display setting (discussed later) is “on” in a state in which the electronic device 1 is connected to a commercial power supply and turned off. Further, the demonstration display is controlled by the microcomputer 11 which executes the demonstration display control programs.

The demonstration display shows, for example, character strings such as “5 DISK CHANGER” indicating a disk changer function and “S-MASTER DIGITAL AMPLIFIERS” indicating the functions of built-in amplifiers. These character strings are displayed in a predetermined order or at random. When the number of characters in character strings exceeds the number of characters displayable on the display part 9, the character strings are scrolled.

Whether the demonstration display should be shown or not is decided according to the demonstration display setting stored in the nonvolatile RAM of the microcomputer 11. To be specific, when the demonstration display setting is “on”, the electronic device 1 shows the demonstration display; meanwhile when the demonstration display setting is “off”, the electronic device 1 does not show the demonstration display. The demonstration display setting can be arbitrarily changed on the setting menu which is started using the remote commander 20.

Actually, the demonstration display is shown to demonstrate the electronic device 1 to customers in stores to promote sales. Thus, in the electronic device 1 according to an embodiment of the present invention, the default demonstration display setting is “on” upon shipment from a factory. Thus, the demonstration display can be automatically started only by connecting the electronic device 1 to a commercial power supply in a store.

It is desirable that the demonstration display should not be frequently canceled by customers in stores; meanwhile the demonstration display is not necessary when the user purchases the electronic device 1 for home use.

For this reason, in the electronic device 1 according to an embodiment of the present invention, when the electronic device 1 is turned on using the power supply button 21 of the remote commander 20, the demonstration display setting is automatically changed from “on” to “off”. Thus, when the user purchases the electronic device 1 and starts using the device, the default demonstration display setting is automatically changed to “off” only by pressing the power supply button 21 of the remote commander 20 and the demonstration display is not shown thereafter.

In stores, by exhibiting only the electronic device 1 with no remote commander 20, it becomes difficult for customers to turn on the electronic device 1 or start the setting menu by using the remote commander 20. Thus, it is possible to positively prevent customers from uselessly canceling the demonstration display.

In some stores, it may be necessary to exhibit the remote commander 20 together with the electronic device 1. In this case, customers may turn on the electronic device 1 by using the remote commander 20 and thus the demonstration display setting may be automatically changed to “off”. In this case, the demonstration display setting is changed again from “off” to “on” on the setting menu.

Further, the electronic device 1 stores, in the nonvolatile RAM, a history of changes of the demonstration display setting on the setting menu. In the case of a change in the demonstration display setting on the setting menu in the past, even when the electronic device 1 is turned on using the remote commander 20, the demonstration display setting is not automatically changed to “off”.

Hence, when the electronic device 1 and the remote commander 20 are both exhibited in stores, once the demonstration display setting is changed to “on” on the setting menu, the demonstration display can be continued even when customers turn on the electronic device 1 by using the remote commander 20.

(3) Steps of Demonstration Display Control

Referring to the flowchart of FIG. 4, the following will specifically discuss the steps of demonstration display control in which the microcomputer 11 acting as display control means and setting changing means executes the demonstration display control programs to control the demonstration display.

When the main power supply 13 is first connected to a commercial power supply after the electronic device 1 is shipped from a factory, the microcomputer 11 of the electronic device 1 enters the start step of demonstration display control routine RT1 and shifts to step SP1. It is confirmed that the default demonstration display setting is “on” in the nonvolatile PAM upon shipment from a factory, and then the process shifts to step SP2. At this point, the electronic device 1 is still turned off.

In step SP2, the microcomputer 11 decides whether the demonstration display setting is “on” or not. When the demonstration display setting is “on” in step SP2, the microcomputer 11 acting as the display control means shifts to step SP3 to start the demonstration display and then shifts to step SP4. In step SP4, the microcomputer 11 waits for a power-on operation using the power supply button 3 of the electronic device 1 and the power supply button 21 of the remote commander 20. When the microcomputer 11 receives the power-on operation, the process shifts to subsequent step SP7.

When the demonstration display setting is “off” in step SP2, the microcomputer 11 acting as the display control means shifts to step SP5 and then shifts to step SP6 without showing the demonstration display. In step SP6, the microcomputer 11 waits for a power-on operation using the power supply button 3 of the electronic device 1 and the power supply button 21 of the remote commander 20. When the microcomputer 11 detects the power-on operation, the microcomputer 11 shifts to subsequent step SP7.

In step SP7, the microcomputer 11 acting as the setting changing means decides the presence or absence of a history of changes in the demonstration display setting on the setting menu. In step SP7, when the microcomputer 11 decides that a history of setting changes on the setting menu is absent, the microcomputer 11 shifts to step SP8 to decide whether the detected power-on operation is performed using the power supply button 21 of the remote commander 20.

When a positive result is obtained in step SP8, the result indicates that the power-on operation is performed using the remote commander 20 in a state in which the setting has not been changed on the setting menu in the past. At this point, the microcomputer 11 acting as the setting changing means shifts to step SP9 and changes the demonstration display setting to “off”. And then, the microcomputer 11 shifts to step SP10 to start the overall electronic device 1. Hence, when the electronic device 1 is first turned on by the remote commander 20 after the electronic device 1 is shipped from a factory, the demonstration display is canceled.

When a negative result is obtained in step SP8, the result indicates that the power-on operation is performed using the power supply button 3 of the electronic device 1 in a state in which the setting has not been changed on the setting menu in the past. At this point, the microcomputer 11 acting as the setting changing means shifts to step SP10 without changing the demonstration display setting and starts the overall electronic device 1. Thus, the electronic device 1 continues the demonstration display until a power-on operation is first performed using the remote commander 20 after shipment from a factory.

In step SP7, when the microcomputer 11 decides that a history of setting changes on the setting menu is present, the result indicates that the demonstration display setting has been intentionally changed by the user on the setting menu in the past. At this point, the microcomputer 11 acting as the setting changing means shifts to step SP10 without changing the demonstration display setting and starts the overall electronic device 1. Hence, in the electronic device 1, when the demonstration display setting is changed to “on” on the setting menu after a power-on operation is performed using the remote commander 20 and the demonstration display setting is automatically set at “off”, the setting change made by the user is respected and the demonstration display is continued.

Then, in subsequent step SP11, the microcomputer 11 waits for a power-off operation using the power supply button 3 of the electronic device 1 and the power supply button 21 of the remote commander 20. When the microcomputer 11 detects the power-off operation, the microcomputer 11 shifts to step SP12 to stop the operation of the electronic device 1 and then returns to step SP2.

(4) Operation and Effect

According to the above configuration, when the electronic device 1 is turned off and the demonstration display setting is “on”, the demonstration display is shown on the display part 9.

Since the default demonstration display setting is “on” in the electronic device 1 upon shipment from a factory, the demonstration display can be automatically started only by connecting the electronic device 1 to a commercial power supply in a store.

When the electronic device 1 receives a power-on operation using the power supply button 21 of the remote commander 20, the electronic device 1 refers to a history of changes in the demonstration display setting on the setting menu. In the absence of a history of setting changes, the demonstration display setting is changed to “off” and then the electronic device 1 is started.

The user who has purchased the electronic device 1 only has to turn on the electronic device 1 with the remote commander 20. Thus, the demonstration display can be automatically canceled without the need for the user to perform a complicated canceling operation.

Moreover, in the electronic device 1, the demonstration display setting can be changed only by a power-on operation using the remote commander 20 or the setting menu started by the remote commander 20.

Thus, only by preventing the remote commander 20 from being exhibited with the electronic device 1 in stores, it is possible to protect the demonstration display setting and prevent customers from uselessly canceling the demonstration display.

Additionally, in the presence of a history of changes in the demonstration display setting on the setting menu, even when a power-on operation using the remote commander 20 is received, the electronic device 1 does not change the demonstration display setting.

Therefore, even when it is necessary to exhibit the electronic device 1 with the remote commander 20 in stores, by changing the demonstration display setting to “on” on the setting menu, a power-on operation performed by customers with the remote commander 20 does not change the demonstration display setting to “off”, so that the demonstration display in a power-off state can be continued.

According to this configuration, the demonstration display can be automatically started only by connecting the electronic device 1 in the initial state to a commercial power supply, the demonstration display can be canceled only by a power-on operation using the remote commander 20, and the demonstration display can be positively shown by changing the demonstration display setting to “on” on the setting menu.

(5) Another Embodiment

The foregoing embodiment described that the present invention is applied to the electronic device 1 which is a DVD player. The present invention is not limited to this embodiment but is widely applicable to various electronic devices having display parts, for example, audio equipment including an audio amplifier and a surround processor. The electronic device and display control method according to an embodiment of the present invention is applicable to various electronic devices having display parts.

It should be understood by those skilled in the art that various modifications, combinations, sub-combinations and alterations may occur depending on design requirements and other factors insofar as they are within the scope of the appended claims or the equivalents thereof.

1. An electronic device enabling demonstration display on a display part in a power-off state,
the device comprising:
display control means for showing the demonstration display on the display part when a demonstration display setting for deciding whether the demonstration display should be shown or not is “on”, and showing no demonstration display when the demonstration display setting is “off”; and
setting changing means for changing the demonstration display setting to “off” when the electronic device is turned on through an external operating device.

2. The electronic device according to claim 1, wherein the demonstration display setting is “on” in an initial state of the electronic device.

3. The electronic device according to claim 1, wherein in the case of a change in the demonstration display setting on a predetermined setting menu, even when the electronic device is turned on through the external operating device, the setting changing means does not change the demonstration display setting.

4. The electronic device according to claim 3, wherein the setting on the setting menu can be changed only through the external operating device.

5. A display control method of demonstration display in an electronic device enabling the demonstration display in a power-off state,
the method comprising:
a display step of showing the demonstration display on a display part when a demonstration display setting for deciding whether the demonstration display should be shown or not is “on”, and showing no demonstration display when the demonstration display setting is “off”; and
a setting changing step of changing the demonstration display setting to “off” when the electronic device is turned on through an external operating device.

6. The display control method according to claim 5, wherein the demonstration display setting is “on” in an initial state of the electronic device.

7. The display control method according to claim 5, wherein in the case of a change in the demonstration display setting on a predetermined setting menu, even when the electronic device is turned on through the external operating device, the demonstration display setting is not changed in the setting changing step.

8. The display control method according to claim 7, wherein the setting on the setting menu can be changed only through the external operating device.
